(19) United States
(12) Patent Application Publication
(10) Pub. No.: US 2023/0168800 A1
(43) Pub. Date: Jun. 1, 2023

(54) DISPLAY DEVICE, DISPLAY METHOD, RECORDING MEDIUM RECORDING DISPLAY PROGRAM

(71) Applicant: SHARP KABUSHIKI KAISHA, Sakai City (JP)

(72) Inventor: KOICHI SUGIYAMA, Sakai City (JP)

(21) Appl. No.: 17/992,941

(22) Filed: Nov. 23, 2022

(30) Foreign Application Priority Data
Nov. 29, 2021 (JP) 2021-192829

(51) Int. Cl. G06F 3/0488; G06F 3/044; G06F 3/04817; G06F 3/04845

(52) U.S. Cl. CPC G06F 3/0488; G06F 3/044; G06F 3/04817; G06F 3/04845; G06F 3/04842

(57) ABSTRACT

A display device includes a detection processor that detects a detection value corresponding to a capacitance generated between an inputter and a display screen, a display processor that displays an input operation icon in a first display form on the display screen when the detection value detected by the detection processor is equal to or larger than a first threshold and displays the input operation icon in a second display form on the display screen when the detection value detected by the detection processor is equal to or larger than a second threshold, and a reception processor that receives an operation of selecting a target using the input operation icon when the detection value detected by the detection processor is equal to or larger than the second threshold.

### INCORPORATION BY REFERENCE

This application is based upon and claims the benefit of priority from the corresponding Japanese Patent Application No. 2021-192829 filed on Nov. 29, 2021, the entire contents of which are incorporated herein by reference.

### BACKGROUND

The present disclosure relates to a display device that receives a contactless input operation performed by a user on a display screen, a display method, and a recording medium having a display program recorded therein.

In general, a display device that allows a contactless input operation (a screen operation), such as an instruction operation, performed on a display screen of a display panel has been used. For example, in a capacitive information processing apparatus having a touch sensor that detects a touch operation and a hover operation, a technique of, when a hover operation is detected on an icon displayed in a display region, changing a display size of a hover mark according to a size of the icon has been used. Note that the hover operation described above corresponds to a contactless input operation of performing input in a floating state (a hover state) in which an inputter, such as a finger or a touch pen (a stylus pen, an electronic pen, etc.), is not in contact with the display screen.

However, with the general technique, it is difficult for a user to recognize an appropriate distance of the inputter from the display screen for reception of the input operation when the hover operation is performed, resulting in poor operability.

### SUMMARY

An object of the present disclosure is to provide a capacitive display device that receives a contactless input operation performed by an inputter on a display screen, a display method, and a recording medium recording a display program, that improve operability of the display device.

According to an aspect of the present disclosure, a capacitive display device that receives a contactless input operation performed by an inputter on a display screen includes a detection processor that detects a detection value corresponding to a capacitance generated between the inputter and the display screen, a display circuit that displays an input operation icon in a first display form on the display screen when the detection value detected by the detection processor is equal to or larger than a first threshold and displays the input operation icon in a second display form on the display screen when the detection value detected by the detection processor is equal to or larger than a second threshold, and a reception circuit that receives an operation of selecting a target using the input operation icon when the detection value detected by the detection processor is equal to or larger than the second threshold.

According to another aspect of the present disclosure, a capacitive display method that receives a contactless input operation performed by an inputter on a display screen causes at least one processor to execute a detection step of detecting a detection value corresponding to a capacitance generated between the inputter and the display screen, a display step of displaying an input operation icon in a first display form on the display screen when the detection value detected by the detection is equal to or larger than a first threshold and displaying the input operation icon in a second display form on the display screen when the detection value detected by the detection is equal to or larger than a second threshold, and a reception step of receiving an operation of selecting a target using the input operation icon when the detection value detected by the detection is equal to or larger than the second threshold.

According to a further aspect of the present disclosure, a recording medium records a capacitive display program that receives a contactless input operation performed by an inputter on a display screen causes at least one processor to execute a detection step of detecting a detection value corresponding to a capacitance generated between the inputter and the display screen, a display step of displaying an input operation icon in a first display form on the display screen when the detection value detected by the detection is equal to or larger than a first threshold and displaying the input operation icon in a second display form on the display screen when the detection value detected by the detection is equal to or larger than a second threshold, and a reception step of receiving an operation of selecting a target using the input operation icon when the detection value detected by the detection is equal to or larger than the second threshold.

According to the present disclosure, there is provided a capacitive display device that receives a contactless input operation performed by an inputter on a display screen, a display method, and a recording medium recording a display program, that improve operability of the display device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a configuration of a display device according to an embodiment of the present disclosure.

FIG. 2 is a diagram schematically illustrating an example of a hover operation in the display device according to the embodiment of the present disclosure.

FIG. 3 is a diagram schematically illustrating an example of a hover operation in the display device according to the embodiment of the present disclosure.

FIG. 4 is a diagram illustrating a configuration of a touch sensor according to the embodiment of the present disclosure.

FIG. 5 is a diagram schematically illustrating an example of a hover operation in the display device according to the embodiment of the present disclosure.

FIG. 6A is a diagram schematically illustrating an example of a hover operation in the display device according to the embodiment of the present disclosure.

FIG. 6B is a diagram illustrating an example of a display screen according to the embodiment of the present disclosure.

FIG. 7A is a diagram schematically illustrating an example of a hover operation in the display device according to the embodiment of the present disclosure.

FIG. 7B is a diagram illustrating an example of a display screen of according to the embodiment of the present disclosure.

FIG. 8 is a diagram schematically illustrating an example of a hover operation in the display device according to the embodiment of the present disclosure.

FIG. 9 is a flowchart of an example of a procedure of a display control process executed in the display device according to the embodiment of the present disclosure.

FIG. 10 is a diagram illustrating a configuration of the touch sensor according to the embodiment of the present disclosure.

FIG. 11A is a diagram illustrating an example of a method for inputting a signal in the display device according to the embodiment of the present disclosure.

FIG. 11B is a diagram illustrating the example of the method for inputting a signal in the display device according to the embodiment of the present disclosure.

FIG. 11C is a diagram illustrating the example of the method for inputting a signal in the display device according to the embodiment of the present disclosure.

FIG. 12A is a graph illustrating an example of a method for detecting an input position in the display device according to the embodiment of the present disclosure.

FIG. 12B is a graph illustrating the example of the method for detecting an input position in the display device according to the embodiment of the present disclosure.

FIG. 12C is a graph illustrating the example of the method for detecting an input position in the display device according to the embodiment of the present disclosure.

FIG. 12D is a graph illustrating the example of the method for detecting an input position in the display device according to the embodiment of the present disclosure.

FIG. 12E is a graph illustrating the example of the method for detecting an input position in the display device according to the embodiment of the present disclosure.

FIG. 13 is a graph illustrating the example of the method for detecting an input position in the display device according to the embodiment of the present disclosure.

FIG. 14 is a flowchart of an example of a procedure of an input detection process executed in the display device according to the embodiment of the present disclosure.

### DETAILED DESCRIPTION

Hereinafter, an embodiment of the present disclosure will be described with reference to the accompanying drawings. Note that the following embodiment is merely an example that embodies the present disclosure, and does not intend to limit the technical scope of the present disclosure.

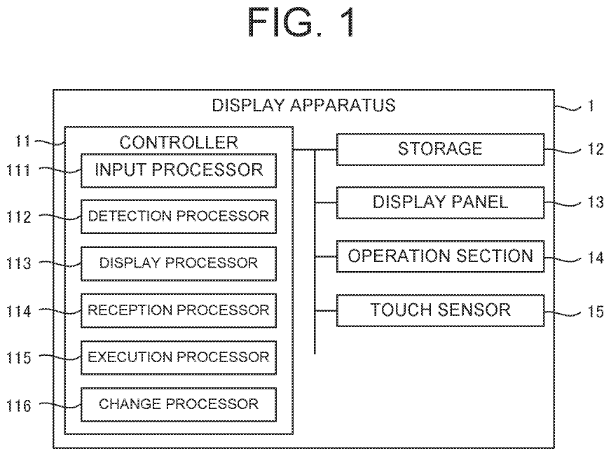

As illustrated in FIG. 1, a display device 1 according to the embodiment of the present disclosure includes a controller 11, a storage 12, a display panel 13, an operation section 14, and a touch sensor 15.

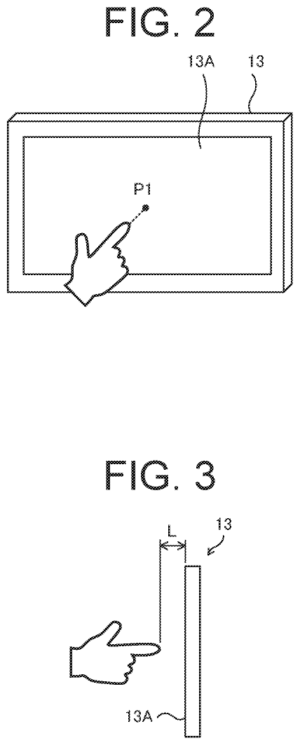

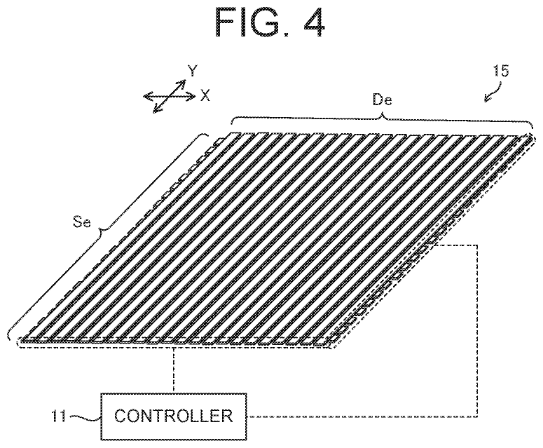

The display device 1 employs a capacitive method and accepts a contactless input operation (hereinafter referred to as a hover operation) performed by the user on a display screen 13A. For example, as illustrated in FIGS. 2 and 3, the display device 1 detects, when a finger of a user approaches the display screen 13A and a distance L between the finger and the display screen 13A becomes equal to or smaller than a predetermined distance, the finger so as to detect a hover operation in accordance with a position of the finger. Subsequently, the display device 1 executes an input process corresponding to the hover operation performed by the user on the display screen 13A. For example, when the user performs a hover operation in a predetermined position over the display screen 13A, the display device 1 detects a position on the display screen 13A corresponding to the position of the hover operation and receives a selection operation of selecting a target using an input operation icon P1 displayed on the display screen 13A.

The hover operation corresponds to an operation of fitting the input operation icon P1 (e.g., a cursor) to a specific element by an inputter (e.g., a user's hand, a fingertip, a stylus pen, a support rod, etc.) for the display screen 13A, and further corresponds to a state before the inputter is in contact with the display screen 13A (a hover state with the inputter floating in the air). The hover state refers to a state in which a distance between the inputter and the display screen 13A is equal to or smaller than a predetermined distance and the inputter is not in contact with the display screen 13A, that is, a state in which the inputter is positioned close to the display screen 13A.

Note that the display device 1 can receive an input operation by a touch by the user on the display screen 13A (hereinafter referred to as a “touch operation”). A selection operation of selecting a target using the input operation icon P1 in response to the touch operation is a generally-known technique, and therefore, a description thereof is omitted hereinafter.

The following is a description of a specific configuration of the hover operation in the display device 1.

The display panel 13 is a display that shows an image, and is a liquid-crystal display, for example. The operation section 14 is an operation device including a mouse and a keyboard, for example. Alternatively, the operation section 14 may be configured by a touch panel.

The touch sensor 15 is, for example, a surface-type or a projection-type capacitive sensor. Note that the touch sensor 15 may be configured by a touch panel superimposed on a surface of the display panel 13. FIG. 4 is a diagram illustrating a configuration of the touch sensor 15. The touch sensor 15 has a plurality of drive electrodes De (driving electrodes) arrayed in an X direction and a plurality of sense electrodes Se (detection electrodes) arranged in a Y direction. The controller 11 inputs drive signals (drive signals) to the drive electrodes De, and the sense electrodes Se output sense signals (detection signals) to the controller 11. The sense signals correspond to capacitance values between the drive electrodes De and the sense electrodes Se. The controller 11 detects an input position on the display screen 13A corresponding to the hover operation based on a change in the capacitance values corresponding to the sense signals.

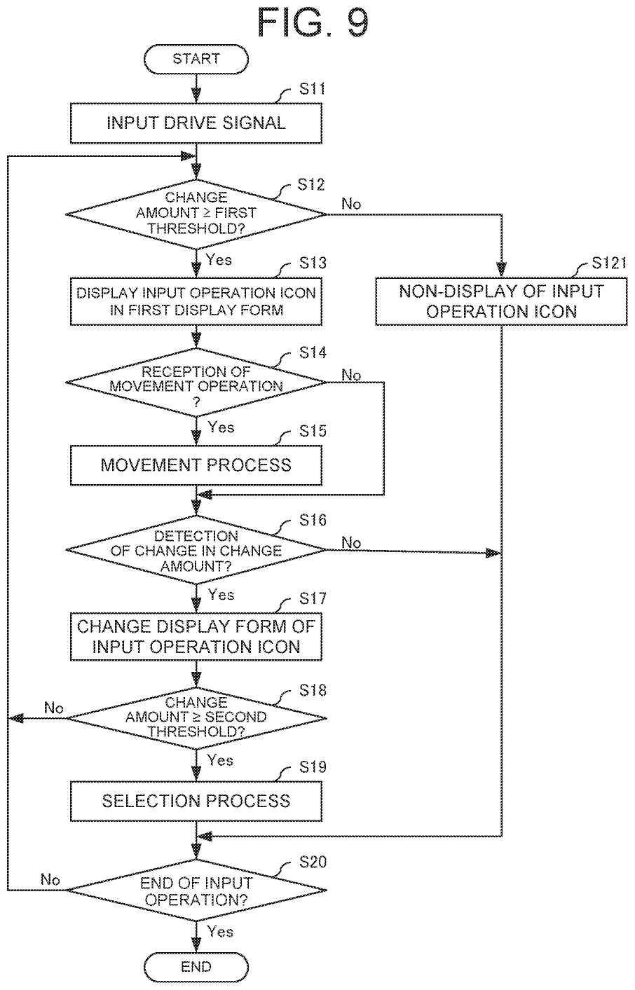

The storage 12 is a non-volatile storage, such as an HDD (hard disk drive) or an SSD (solid state drive) that stores various types of information. The storage 12 stores a control program, such as a display control program for causing the controller 11 to execute a display control process (refer to FIG. 9), which will be described below. For example, the display control program is recorded in a non-transitory manner in a computer-readable recording medium, such as a CD or a DVD, is read by a reader (not illustrated), such as a CD drive or a DVD drive, provided in the display device 1, and is stored in the storage 12. Note that the display control program may be distributed from a cloud server and stored in the storage 12.

The controller 11 includes control devices, such as a CPU, ROM, and RAM. The CPU is a processor that executes various types of calculation processing. The ROM is a non-volatile storage that stores, in advance, control programs of the BIOS, an OS, and the like to cause the CPU to execute the various types of calculation processing. The RAM is a volatile or non-volatile storage that stores various types of information, and is used as temporary storage memory (a workspace) for various processes to be executed by the CPU. The controller 11 causes the CPU to execute the various control programs, which are stored in the ROM or the storage 12 in advance, to control the display device 1.

Specifically, as illustrated in FIG. 1, the controller 11 includes various processors, such as an input processor 111, a detection processor 112, a display processor 113, a reception processor 114, an execution processor 115, and a change processor 116. Note that the controller 11 functions as the input processor 111, the detection processor 112, the display processor 113, the reception processor 114, the execution processor 115, and the change processor 116, when the CPU executes various processes in accordance with the display control program. Furthermore, all or some of the processors included in the controller 11 may be configured by an electronic circuit. Note that the display control program may cause a plurality of processor devices to function as the various processors.

The input processor 111 inputs drive signals (driving signals) to the touch sensor 15. Specifically, the input processor 111 successively inputs drive signals to the drive electrodes De of the touch sensor 15. Note that the input processor 111 may input drive signals to a drive electrode group Dg (described below) including the plurality of drive electrodes De. Furthermore, the input processor 111 may boost voltages of the drive signals before inputting the drive signals to the drive electrodes De. This increases the electric lines of force between the drive electrodes De and the sense electrodes Se, and accordingly, an amount of change in capacitance described below is easily detected.

The detection processor 112 detects detection values in accordance with a capacitance generated between the inputter and the display screen 13A. For example, the detection processor 112 receives sense signals output from the sense electrodes Se in accordance with the drive signals input to the drive electrodes De, and detects an amount of change in the capacitance based on the sense signals. The detection processor 112 detects an input position of the hover operation based on the amount of change. Note that the detection processor 112 may perform a process of increasing an input gain and a filtering process of removing noise on the received sense signals. The detection processor 112 is an example of a detection processor of the present disclosure.

The display processor 113 displays the input operation icon P1 on the display screen 13A. Specifically, the display processor 113 displays the input operation icon P1 on the display screen 13A in a first display form when the detection value detected by the detection processor 112 is equal to or larger than a first threshold, and displays the input operation icon P1 on the display screen 13A in a second display form when the detection value detected by the detection processor 112 is equal to or larger than a second threshold. The display processor 113 is an example of a display processor according to the present disclosure.

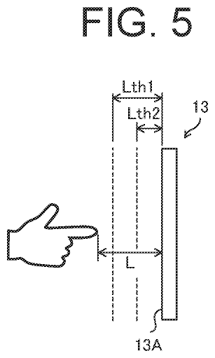

For example, as illustrated in FIG. 5, when a distance L between a finger of the user and the display screen 13A is larger than a predetermined distance Lth1, an amount of change in the capacitance detected by the detection processor 112 is smaller than the first threshold, and therefore, the display processor 113 does not display the input operation icon P1 on the display screen 13A.

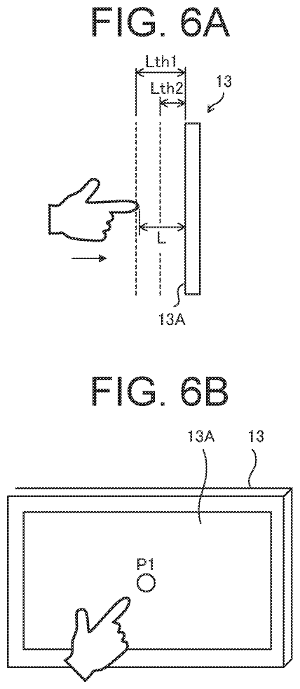

On the other hand, as illustrated in FIG. 6A, for example, when the finger of the user approaches the display screen 13A and the distance L between the finger and the display screen 13A becomes equal to or smaller than the predetermined distance Lth1, an amount of change in capacitance detected by the detection processor 112 becomes equal to or larger than the first threshold. In this case, as illustrated in FIG. 6B, the display processor 113 displays the input operation icon P1 on the display screen 13A in the first display form (an outer edge of a circle is displayed in black and an inside of the circle is displayed in white).

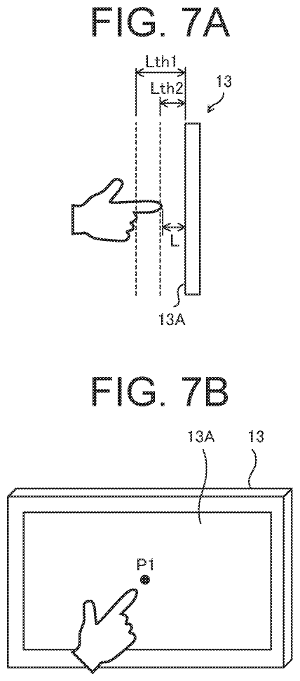

On the other hand, as illustrated in FIG. 7A, for example, when the finger of the user further approaches the display screen 13A and the distance L between the finger and the display screen 13A becomes equal to or smaller than a predetermined distance Lth2, an amount of change in capacitance detected by the detection processor 112 becomes equal to or larger than the second threshold. In this case, as illustrated in FIG. 7B, the display processor 113 displays the input operation icon P1 on the display screen 13A in the second display form (an outer edge of a circle and an inside of the circle are displayed in black).

The reception processor 114 receives a movement operation of moving the input operation icon P1 when the detection value detected by the detection processor 112 is equal to or larger than the first threshold and smaller than the second threshold. Specifically, as illustrated in FIG. 7A, when the distance L between the finger of the user and the display screen 13A is equal to or smaller than the predetermined distance Lth1 and equal to or larger than the predetermined distance Lth2 and when an amount of change in capacitance is equal to or larger than the first threshold and smaller than the second threshold, the reception processor 114 receives the movement operation of moving the input operation icon P1.

The reception processor 114 receives a selection operation of selecting a target using the input operation icon P1 when the detection value detected by the detection processor 112 is equal to or larger than the second threshold. Specifically, as illustrated in FIG. 7A, when the distance L between the finger of the user and the display screen 13A is equal to or smaller than the predetermined distance Lth2 and when an amount of change in capacitance is equal to or larger than the second threshold, the reception processor 114 receives the selection operation of selecting a target using the input operation icon P1. The reception processor 114 is an example of a reception processor according to the present disclosure.

The execution processor 115 executes an input process corresponding to an input operation received by the reception processor 114. Specifically, when the movement operation or the selection operation is received, the execution processor 115 performs an input process corresponding to an input operation performed by the user on the display screen 13A. For example, when the reception processor 114 receives the movement operation, the execution processor 115 moves the input operation icon P1 on the display screen 13A. For example, when the reception processor 114 receives the selection operation, the execution processor 115 performs a process corresponding to a selected target on the display screen 13A. The execution processor 115 is an example of an execution processor according to the present disclosure.

The change processor 116 changes a display form of the input operation icon P1 based on the detection value detected by the detection processor 112. Specifically, the change processor 116 changes a display form of the input operation icon P1 between the first display form and the second display form in accordance with the detection value step by step or continuously, when the detection value detected by the detection processor 112 is equal to or larger than the first threshold and smaller than the second threshold. The change processor 116 is an example of a change processor according to the present disclosure.

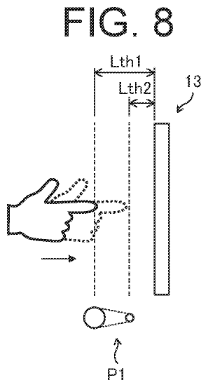

For example, as illustrated in FIG. 8, the change processor 116 reduces a size of the input operation icon P1 step by step or continuously as the finger of the user approaches the display screen 13A. As another embodiment, the change processor 116 may change a shape, a color, brightness, or tone of the input operation icon P1 step by step or continuously as the finger of the user approaches the display screen 13A.

As a further embodiment, the controller 11 may output first sound when the detection value detected by the detection processor 112 is equal to or larger than the first threshold, output second sound when the detection value is equal to or larger than the second threshold, and change a volume of the sound in accordance with the detection value when the detection value is equal to or larger than the first threshold and smaller than the second threshold.

Display Control Process

A description will be made hereinafter on the display control process that is executed by the controller 11 of the display device 1 with reference to FIG. 9.

Note that the present disclosure may be regarded as a disclosure of a display control method (an example of a display method according to the present disclosure) for executing one or more steps included in the display control process, and one or more steps included in the display control process described herein may be omitted as appropriate. The steps of the display control process may be executed in a different order as long as the similar function effect is obtained. Furthermore, a description will be made herein on a case where the controller 11 executes the steps in the display control process as an example. However, the display control method in which a plurality of processors execute the steps in the display control process in a distributed manner is regarded as another embodiment.

First, in step S11, the controller 11 inputs drive signals (driving signals) to the touch sensor 15. Specifically, the controller 11 inputs drive signals to the drive electrodes De.

The controller 11 continues the process of inputting drive signals at a predetermined cycle until an input operation of the user is terminated.

Next, in step S12, the controller 11 detects a detection value (an amount of change) in accordance with capacitance generated between the inputter (the finger of the user in this embodiment) and the display screen 13A, and determines whether the amount of change is equal to or larger than the first threshold. When determining that the amount of change is equal to or larger than the first threshold (S12: Yes), the controller 11 proceeds to step S13. On the other hand, when determining that the amount of change is smaller than the first threshold (S12: No), the controller 11 proceeds to step S121.

In step S13, the controller 11 displays the input operation icon P1 in the first display form on the display screen 13A. For example, as illustrated in FIG. 6A, for example, when the finger of the user approaches the display screen 13A and the distance L between the finger and the display screen 13A becomes equal to or smaller than the predetermined distance Lth1, the amount of change becomes equal to or larger than the first threshold. In this case, as illustrated in FIG. 6B, the controller 11 displays the input operation icon P1 on the display screen 13A in the first display form (an outer edge of a circle is displayed in black and an inside of the circle is displayed in white).

Subsequently, in step S14, the controller 11 determines whether a movement operation of the input operation icon P1 has been received. For example, when the amount of change is within a predetermined range and a detection position (an X coordinate and a Y coordinate) of the detection value is changed, the controller 11 determines that the movement operation of the input operation icon P1 has been received. After receiving the movement operation of the input operation icon P1 (S14: Yes), the controller 11 proceeds to step S15. On the other hand, when the movement operation of the input operation icon P1 has not been received (S14: No), the controller 11 proceeds to step S16.

In step S15, the controller 11 moves the position of the input operation icon P1 displayed on the display screen 13A in accordance with the movement operation.

Next, in step S16, the controller 11 determines whether the amount of change based on the capacitance has been changed. When determining that the amount of change has been changed (S16: Yes), the controller 11 proceeds to step S17. On the other hand, when determining that the amount of change has not been changed (S16: No), the controller 11 proceeds to step S20.

In step S17, the controller 11 changes the display form of the input operation icon P1 displayed on the display screen 13A. Specifically, the controller 11 changes the display form of the input operation icon P1 in accordance with the amount of change.

For example, as illustrated in FIG. 8, the controller 11 reduces the size of the input operation icon P1 step by step or continuously as the finger of the user approaches the display screen 13A. As another embodiment, the controller 11 may change a shape, a color, brightness, or tone of the input operation icon P1 step by step or continuously as the finger of the user approaches the display screen 13A.

Subsequently, in step S18, the controller 11 determines whether the amount of change is equal to or larger than the second threshold. When determining that the amount of change is equal to or larger than the second threshold (S18: Yes), the controller 11 proceeds to step S19. On the other hand, when determining that the amount of change is smaller than the second threshold (S18: No), the controller 11 returns to step S12.

Here, returning to step S12, when the amount of change is smaller than the first threshold (S12: No) (refer to FIG. 5), the controller 11 proceeds to step S121 to delete the input operation icon P1 from the display screen 13A. In the state of FIG. 6A, for example, when the user moves the finger away from the display screen 13A, and therefore, the distance L between the finger and the display screen 13A becomes larger than the predetermined distance Lth1 (refer to FIG. 5), the controller 11 brings the input operation icon P1 into a non-display state.

In step S19, the controller 11 receives an operation of selecting a target on the display screen 13A and executes a process corresponding to the selected target.

Subsequently, in step S20, the controller 11 determines whether the input operation has been terminated. When the user terminates the input operation on the display screen 13A, the controller 11 determines that the input operation has been terminated (S20: Yes), and terminates the display control process. On the other hand, when the user continues the input operation on the display screen 13A, the controller 11 determines that the input operation has not been terminated (S20: No), and returns to step S12. The controller 11 thus executes the display control process.

As described above, the display device 1 of this embodiment detects a detection value in accordance with capacitance generated between the inputter and the display screen 13A, and displays, when the detection value is equal to or larger than the first threshold, the input operation icon P1 on the display screen 13A in the first display form, and displays, when the detection value is equal to or larger than the second threshold, the input operation icon P1 on the display screen 13A in the second display form. Furthermore, the display device 1 receives a selection operation of selecting a target using the input operation icon P1 when the detection value is equal to or larger than the second threshold.

According to the above configuration, when a finger of the user approaches the display screen 13A to perform a hover operation, the input operation icon P1 is displayed on the display screen 13A in the first display form, and when the finger further approaches the display screen 13A, the input operation icon P1 is displayed on the display screen 13A in the second display form which enables the selection operation. Accordingly, the user can easily recognize a distance between the finger and the display screen 13A that enables reception of the selection operation, and therefore, operability of the hover operation can be improved.

Method for Detecting Input Position

Other methods for detecting an input position in the hover operation will now be described.

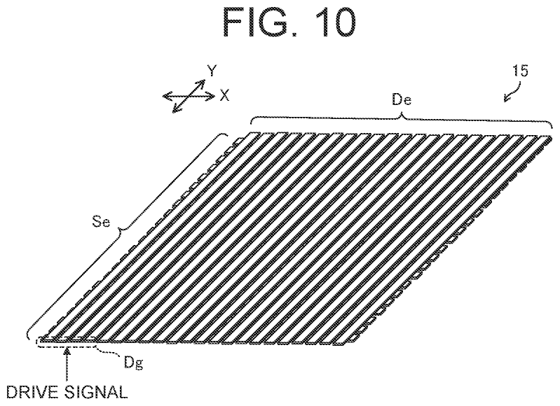

Specifically, as illustrated in FIG. 10, the input processor 111 inputs a drive signal to a drive electrode group Dg including a number of the drive electrodes De that are adjacent to each other. Furthermore, the input processor 111 inputs a drive signal (a first drive signal) to a first drive electrode group Dg1 including a number of the drive electrodes De at a first timing, and inputs a drive signal (a second drive signal) to a second drive electrode group Dg2 including a number of the drive electrodes De included in the first drive electrode group Dg1 and at least one of the drive electrodes De that are adjacent to the first drive electrode group Dg1 at a second timing following the first timing.

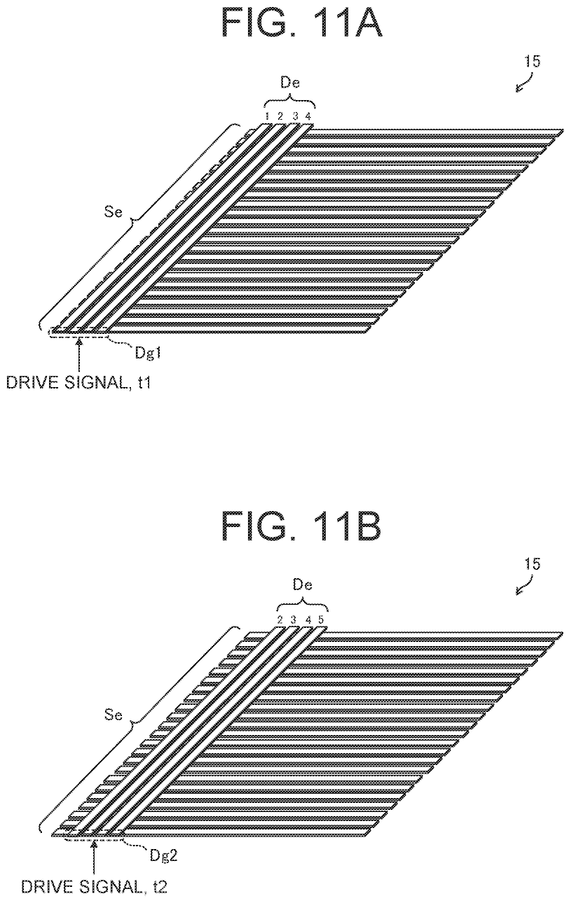

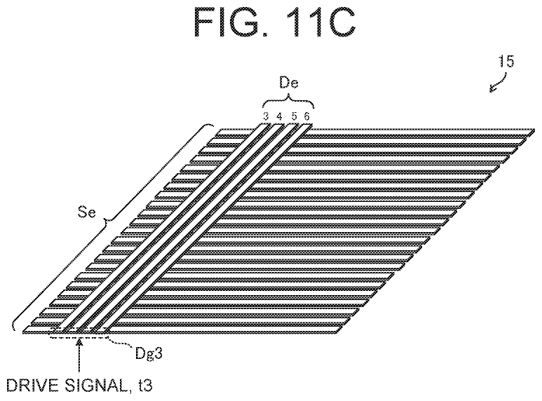

For example, as illustrated in FIGS. 11A to 11C, the input processor 111 inputs a drive signal (a first drive signal) to the first drive electrode group Dg1 including four drive electrodes De, that is, first to fourth drive electrodes De, at a first timing (t1) (refer to FIG. 11A), inputs a drive signal (a second drive signal) to the second drive electrode group Dg2 including four drive electrodes De, that is, second to fifth drive electrodes De, at a second timing (t2) following the first timing (refer to FIG. 11B), and inputs a drive signal (a third drive signal) to a third drive electrode group Dg3 including four drive electrodes De, that is, third to sixth drive electrodes De, at a third timing (t3) following the second timing (refer to FIG. 11C).

Although a case where the drive electrode group Dg includes four drive electrodes De and a drive signal is input to the drive electrode group Dg while shifting the drive electrodes De one by one is illustrated in FIGS. 11A to 11C, the present disclosure is not limited to this as long as two or more drive electrodes De are included in a drive electrode group Dg. Furthermore, the input processor 111 may input a drive signal to the drive electrode group Dg while shifting the drive electrodes De by a plurality of electrodes.

In this way, the input processor 111 inputs a drive signal at different timings while shifting a target range of the drive electrode group Dg for a plurality of drive electrodes De.

The detection processor 112 detects the input position based on a sense signal corresponding to a drive signal input to the drive electrode group Dg. For example, the detection processor 112 detects the input position based on a first sense signal corresponding to the drive signal (the first drive signal) for the first drive electrode group Dg1 and a second sense signal corresponding to the drive signal (the second drive signal) for the second drive electrode group Dg2. Specifically, the detection processor 112 detects the input position based on a plurality of sense signals corresponding to drive signals input to the individual drive electrode groups Dg. Furthermore, the detection processor 112 detects the input position based on a plurality of sense signals corresponding to the individual drive signals input at different timings in a predetermined period of time.

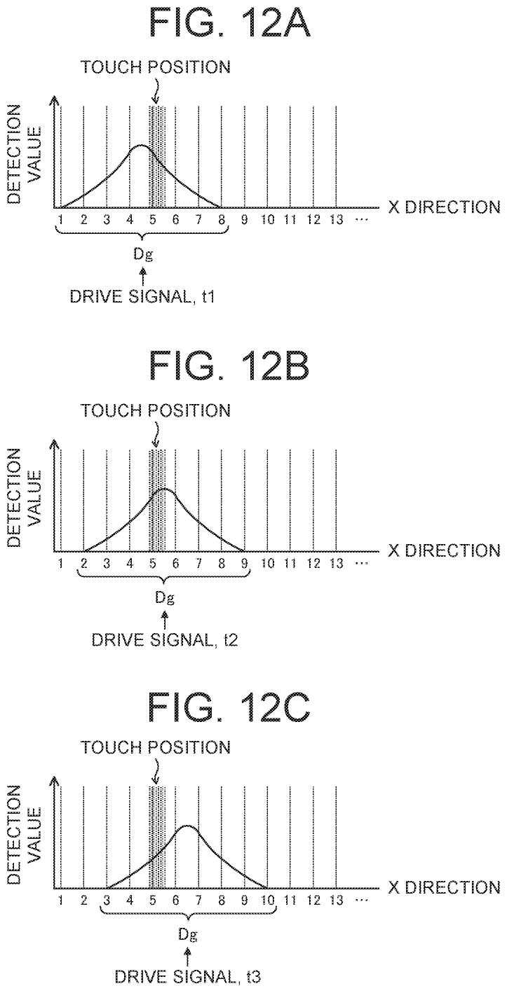

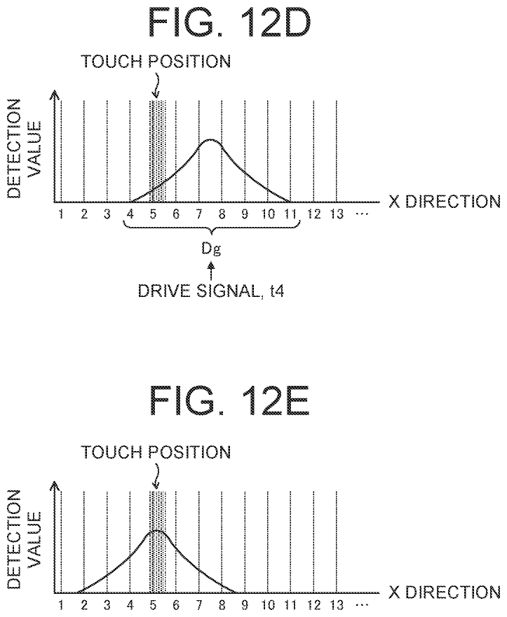

An example of the detection of the input position will now be described with reference to FIGS. 12A to 12E. It is assumed here that the drive electrode group Dg includes eight drive electrodes De, and the input processor 111 inputs a drive signal to each group of eight drive electrodes De. Furthermore, it is assumed here that the user has touched (hovered) near a fifth drive electrode De with a finger.

At a first timing (t1) illustrated in FIG. 12A, the input processor 111 inputs a drive signal (a first drive signal) to a drive electrode group Dg including eight drive electrodes De, that is, first to eighth drive electrodes De, and the detection processor 112 receives sense signals from individual sense electrodes Se. In FIG. 12A, detection values (an amount of change in capacitance) corresponding to the sense signals at the first timing t1 are illustrated.

At a following second timing (t2) (refer to FIG. 12B), the input processor 111 inputs a drive signal to a drive electrode group Dg including eight drive electrodes De, that is, second to ninth drive electrodes De, and the detection processor 112 receives sense signals from individual sense electrodes Se. In FIG. 12B, detection values (an amount of change in capacitance) corresponding to the sense signals at the first timing t2 are illustrated.

At a following third timing (t3) (refer to FIG. 12C), the input processor 111 inputs a drive signal to a drive electrode group Dg including eight drive electrodes De, that is, third to tenth drive electrodes De, and the detection processor 112 receives sense signals from individual sense electrodes Se. In FIG. 12C, detection values (an amount of change in capacitance) corresponding to the sense signals at the third timing t3 are illustrated.

At a following fourth timing (t4) (refer to FIG. 12D), the input processor 111 inputs a drive signal to a drive electrode group Dg including eight drive electrodes De, that is, fourth to 11th drive electrodes De, and the detection processor 112 receives sense signals from individual sense electrodes Se. In FIG. 12D, detection values (an amount of change in capacitance) corresponding to the sense signals at the fourth timing t4 are illustrated.

In this way, the input processor 111 inputs a drive signal at the different timings while shifting a target range of the drive electrode group Dg for the plurality of drive electrodes De, and the detection processor 112 receives sense signals from the individual sense electrodes Se.

Then the detection processor 112 detects the input position based on an average of the detection values corresponding to the plurality of sense signals included in the predetermined period of time. Then the detection processor 112 detects the input position based on the average (refer to FIG. 12E) of the detection values of the plurality of sense signals received in a period from t1 to t4.

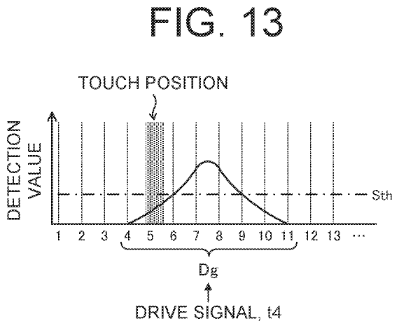

Furthermore, the detection processor 112 may detect the input position based on a specific sense signal having a detection value equal to or larger than a threshold among the plurality of sense signals included in the predetermined period of time. For example, as shown in FIG. 13, when the amount of change in capacitance corresponding to a sense signal is smaller than a threshold Sth, the detection processor 112 excludes the sense signal and detects the input position based on the other sense signals.

Thus, the input processor 111 inputs drive signals to the plurality of drive electrodes De in the drive electrode group Dg at the same timing, and in addition, inputs drive signals to the individual drive electrodes De a number of times while shifting a position of the drive electrode group Dg.

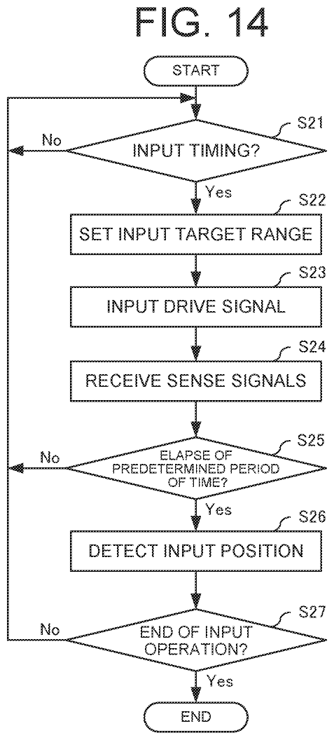

Input Detection Process Hereinafter, the input detection process executed by the controller 11 of the display device 1 will be described with reference to FIG. 14.

First, in step S21, the controller 11 determines whether the timing to input a drive signal has arrived. The timing (a cycle) for inputting a drive signal is set in advance. When the timing to input the drive signal has arrived (S21: Yes), the controller 11 proceeds to step S22. The controller 11 waits until the timing to input a drive signal has arrived (S21: No).

Next, in step S22, the controller 11 sets a target range of the drive electrode group Dg to which a drive signal is to be input. For example, as illustrated in FIG. 12A, the controller 11 sets a drive electrode group Dg including first to eighth drive electrodes De as the target range.

Subsequently, in step S23, the controller 11 inputs a drive signal to the drive electrode group Dg in the set target range. For example, as illustrated in FIG. 12A, the controller 11 inputs a drive signal to the drive electrode group Dg including the first to eighth drive electrodes De at the timing t1.

Thereafter, in step S24, the controller 11 receives sense signals from individual sense electrodes Se.

In step S25, the controller 11 determines whether a predetermined period of time has elapsed. As the predetermined period of time, a period of time in which sense signals corresponding to the same drive electrode De are consecutively received a plurality of times, for example, is set. When determining that the predetermined period of time has elapsed (S25: Yes), the controller 11 proceeds to step S26. On the other hand, when determining that the predetermined period of time has not elapsed (S25: No), the controller 11 returns to step S21.

Returning to step S21, when the next timing t2 has arrived, the controller 11 sets a drive electrode group Dg including second to ninth drive electrodes De as the target range (S22) and inputs a drive signal to the drive electrode group Dg (S23). Then the controller 11 receives sense signals from the individual sense electrodes Se (S24).

The controller 11 repeatedly performs the process from step S21 to step S24 until the predetermined period of time has elapsed (refer to FIGS. 12B to 12D).

When the predetermined period of time has elapsed (S25: Yes), the controller 11 detects an input position in step S26. Specifically, the controller 11 detects the input position based on an average of detection values corresponding to the plurality of sense signals included in the predetermined period of time. In the example described above, the controller 11 detects the input position based on the average (refer to FIG. 12E) of the detection values of the plurality of sense signals received in the period from t1 to t4.

Subsequently, in step S27, the controller 11 determines whether the input operation has been terminated. When the user terminates the input operation performed on the display screen 13A, the controller 11 determines that the input operation has been terminated (S27: Yes), and terminates the display control process. On the other hand, when the user continues the input operation on the display screen 13A, the controller 11 determines that the input operation has not been terminated (S27: No), and returns to step S21. The controller 11 thus executes the input detection process.

According to the configuration described above, the electric lines of force between the drive electrodes De and the sense electrodes Se can be increased by inputting a drive signal to a drive electrode group Dg, which is a bundle of a plurality of drive electrodes De, and accordingly, detection sensitivity for a hover operation can be improved. Furthermore, since a drive signal is input to each drive electrode De a plurality of time, a resolution equivalent to a configuration in which drive signals are input to drive electrodes De one by one can be obtained. Thus, the detection sensitivity for the input operation on the display panel 13 can be improved, as well as the detection accuracy for the input position.

The display device 1 (an input detection apparatus) that executes the input detection process can be configured as follows.

### APPENDIX 1

An input detection device that detects an input position of an inputter on a display panel, the input detection device comprising:

an input processor that inputs a drive signal to an electrode group including a number of electrodes that are arranged adjacent to each other among a plurality of electrodes arranged in parallel on the display panel; and

a detection processor that detects the input position based on a detection signal corresponding to the drive signal input to the electrode group, wherein

the input processor inputs a first drive signal to a first electrode group including a plurality of electrodes at a first timing and inputs, at a second timing subsequent to the first timing, a second drive signal to a second electrode group including a number of the electrodes included in the first electrode group and at least one electrode positioned adjacent to the first electrode group, and

the detection processor detects the input position based on a first detection signal corresponding to the first drive signal and a second detection signal corresponding to the second drive signal.

### APPENDIX 2

The input detection device according to Appendix 1, wherein the input processor inputs the drive signals at different timings while shifting a target range of the electrode group for the plurality of electrodes arranged in parallel on the display panel.

### APPENDIX 3

The input detection device according to Appendix 2, wherein the detection processor detects the input position based on the plurality of detection signals corresponding to the plurality of drive signals input at the different timings in a predetermined period of time.

### APPENDIX 4

The input detection device according to Appendix 3, wherein the detection processor detects the input position based on an average of the detection values corresponding to the plurality of detection signals included in the predetermined period of time.

### APPENDIX 5

The input detection device according to Appendix 3, wherein the detection processor detects the input position based on a specific detection signal having a detection value equal to or larger than a threshold among the plurality of detection signals included in the predetermined period of time.

### APPENDIX 6

The input detection device according to any one of Appendix 1 to Appendix 5, wherein

the input processor
inputs the drive signals respectively to the plurality of electrodes included in the electrode group at the same timing in a first mode in which a contactless input operation performed by the inputter on the display panel is received, and
inputs the drive signals to the different electrodes at respectively different timings in a second mode in which a contact input operation performed by the inputter on the display panel is received.

### APPENDIX 7

An input detection method for detecting an input position of an inputter on a display panel, the input detection method causing

at least one processor to execute:
an input step of inputting a drive signal to an electrode group including a number of electrodes that are arranged adjacent to each other among a plurality of electrodes arranged in parallel on the display panel; and
a detection step of detecting the input position based on a detection signal corresponding to the drive signal input to the electrode group, wherein

in the input step, a first drive signal is input to a first electrode group including a plurality of electrodes at a first timing, and a second drive signal is input to a second electrode group including a number of the electrodes included in the first electrode group and at least one electrode that is adjacent to the first electrode group at a second timing following the first timing, and

in the detection step, the input position is detected based on a first detection signal corresponding to the first drive signal and a second detection signal corresponding to the second drive signal.

### APPENDIX 8

An input detection program for detecting an input position of an inputter on a display panel, the input detection program causing at least one processor to execute:

an input step of inputting a drive signal to an electrode group including a number of electrodes that are arranged adjacent to each other among a plurality of electrodes arranged in parallel on the display panel; and

a detection step of detecting the input position based on a detection signal corresponding to the drive signal input to the electrode group, wherein

in the input step, a first drive signal is input to a first electrode group including a plurality of electrodes at a first timing, and a second drive signal is input to a second electrode group including a number of the electrodes included in the first electrode group and at least one electrode that is adjacent to the first electrode group at a second timing following the first timing, and

in the detection step, the input position is detected based on a first detection signal corresponding to the first drive signal and a second detection signal corresponding to the second drive signal.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A capacitive display device that receives a contactless input operation performed by an inputter on a display screen, the display device comprising:
a detection circuit that detects a detection value corresponding to a capacitance generated between the inputter and the display screen;
a display circuit that displays an input operation icon in a first display form on the display screen when the detection value detected by the detection circuit is equal to or larger than a first threshold and displays the input operation icon in a second display form on the display screen when the detection value detected by the detection circuit is equal to or larger than a second threshold; and
a reception circuit that receives an operation of selecting a target using the input operation icon when the detection value detected by the detection circuit is equal to or larger than the second threshold.

2. The display device according to claim 1, further comprising a change circuit that changes a display form of the input operation icon, step by step or continuously, between the first display form and the second display form in accordance with the detection value detected by the detection circuit, when the detection value is equal to or larger than the first threshold and smaller than the second threshold.

3. The display device according to claim 2, wherein the change circuit changes a size of the input operation icon, step by step or continuously, between the first display form and the second display form.

4. The display device according to claim 2, wherein the change circuit changes a color of the input operation icon, step by step or continuously, between the first display form and the second display form.

5. The display device according to claim 2, wherein the change circuit changes a shape of the input operation icon, step by step or continuously, between the first display form and the second display form.

6. The display device according to claim 1, wherein the reception circuit receives an operation of moving the input operation icon, when the detection value detected by the detection circuit is equal to or larger than the first threshold and smaller than the second threshold.

7. The display device according to claim 6, further comprising an execution circuit that executes an input process corresponding to the input operation performed by the inputter on the display screen, when the reception circuit receives the movement operation or the selection operation.

8. A capacitive display method that receives a contactless input operation performed by an inputter on a display screen, the display method causing at least one processor to:
detect a detection value corresponding to a capacitance generated between the inputter and the display screen;
display an input operation icon in a first display form on the display screen when the detection value detected is equal to or larger than a first threshold and display the input operation icon in a second display form on the display screen when the detection value detected is equal to or larger than a second threshold; and
receive an operation of selecting a target using the input operation icon when the detection value detected is equal to or larger than the second threshold.

9. A non-transitory computer-readable recording medium recording a capacitive display program that receives a contactless input operation performed by an inputter on a display screen, the display program causing at least one processor to execute:
detecting a detection value corresponding to a capacitance generated between the inputter and the display screen;
displaying an input operation icon in a first display form on the display screen when the detection value detected is equal to or larger than a first threshold and displaying the input operation icon in a second display form on the display screen when the detection value detected is equal to or larger than a second threshold; and
receiving an operation of selecting a target using the input operation icon when the detection value is equal to or larger than the second threshold.
